(19) United States
(12) Patent Application Publication
(10) Pub. No.: US 2006/0075863 A1
(43) Pub. Date: Apr. 13, 2006

(54) Cutting machine and manufacturing system for fixed size sheet

(75) Inventors: Takahisa Kashimoto, Yao-shi (JP); Yoshihiko Watanuki, Kobe-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: TEIPI THERMAL ENGINEERING CO., LTD.,, Hirakata-shi (JP); TEIKOKU PISTON RING CO., LTD.,, Tokyo (JP); SUMITOMO CHEMICAL COMPANY, LIMITED, Tokyo (JP)

(21) Appl. No.: 11/242,119

(22) Filed: Oct. 4, 2005

(30) Foreign Application Priority Data
Oct. 8, 2004 (JP) 2004-295872

(51) Int. Cl. B26D 7/02

(52) U.S. Cl. 83/452; 83/694

(57) ABSTRACT

A cutting machine 10 includes an upper blade 12A and a lower blade 12B installed at upper and lower positions, and resilient members 19A, 19B installed on both sides of the blades and protruding more than the blades for supporting a hard plastic sheet 7 during cutting. The resilient members installed on both sides of either of the upper and lower blades include a resilient member at a section near the blade and a resilient member at a section far from the blade, and the hardness of the resilient member at a section near the blade is different from the hardness of the resilient member at a section far from the blade.

### BACKGROUND OF INVENTION

1. Field of Invention

The present invention relates to a cutting machine for cutting a hard plastic sheet, and relates in particular to a cutting machine for cutting a hard plastic sheet such as acrylic sheet with a small percentage of rubber additive, a large width and thin sheet thickness. The present invention further relates to a cutting machine for cutting a continuously flowing hard plastic sheet along the sheet width direction to yield fixed size sheets.

2. Description of Related Art

One cutting method creates a brittle fracture point by driving cutting blades into both the top and bottom surfaces of a hard plastic sheet, to cut by making the brittle fracture propagate along the direction of the sheet thickness. This technology possesses the following features (Refer to Japanese patent Non-Examined Publication No. 7-285099 and Japanese patent Non-Examined Publication No. 2001-47400).

This method does not generate cutting waste that cannot be recycled.

Cutting time is short.

Cutting machine and cutting die are low in cost and yield a cut-out shape with highly accurate cutting dimensions.

Technical improvements on this technology have been disclosed (Refer to Japanese patent Non-Examined Publication No. 2001-322096). In this technology, resilient members thicker than the protruding height of the blade are installed on both sides of the upper and lower blades, and the hard plastic sheet is cut with a difference between the time the upper and lower blades contact the hard plastic sheet to apply a bending deformation to the hard plastic sheet and to generate a perpendicular tensile stress on the cut surface. This technology renders the effect of extending the life of the blades along with simultaneously obtaining a smooth cut surface.

The above technology is limited to cutting work piece of comparatively small dimensions in a process that cuts out the fixed size sheet to obtain a piece of material prior to secondary processing such as vacuum forming or press-forming, and a process to cut out the product after the secondary processing.

Recently, there is a need for cutting without generating cutting waste, in processes for manufacturing fixed size sheets by cutting along the sheet width direction, a hard plastic sheet such as acrylic sheet extruded from an extrusion machine. However, the following technical problems are encountered during this cutting.

The width of the fixed size sheet is large.

The sheet are flowing so a relative vibration occurs between the cutting machine and the sheet.

A high quality cut surface is required since the cut surface is a part of the product.

The hard plastic sheet must be cut so that the protective film does not separate partially in the vicinity of the cut surface.

However, there is no description in Japanese patent Non-Examined Publication No. 2001-322096 on how to construct the resilient members installed on both sides of the upper and lower blades to resolve these technical problems.

### SUMMARY OF INVENTION

To resolve the above described problems, the present invention has an object of providing a cutting machine for cutting with high quality, a hard plastic sheet and particularly a hard plastic sheet such as acrylic sheet with a small percentage of rubber additive, a large width and thin sheet thickness. Moreover, the present invention has another object of providing a cutting machine for cutting a continuously moving hard plastic sheet without generating cutting waste to yield fixed size sheets.

The present invention employs the following means to resolve the above problems. Namely,

The cutting machine of the present invention includes an upper blade and a lower blade installed at upper and lower positions, and resilient members installed on both sides of the blades and protruding more than the blades for supporting a hard plastic sheet during cutting, wherein the resilient members installed on both sides of either of the upper and lower blades include a resilient member at a section near the blade and a resilient member at a section far from the blade; and the hardness of the resilient member at a section near the blade is different from the hardness of the resilient member at a section far from the blade.

In the hardness of the resilient members installed on both sides of either of the upper and lower blades, the following either form is employed.

Hardness of the resilient member at the section near the blade is lower than the hardness of the resilient member at the section far from the blade.

Hardness of the resilient member at the section near the blade is higher than the hardness of the resilient member at the section far from the blade.

In the former case, the cross section of the resilient member far from the blade is preferably a circular or ring shape.

Also, in the former case, a deformation suppressing member is preferably installed to suppress deformation of the resilient member far from the blade.

The tips of the upper and lower blades are normally a linear shape.

The tips of the upper and lower blades of this invention apply a brittle fracture point to the hard plastic sheet. Therefore, it is important that the time differential between when the upper blade and the lower blade are driven, and also the lateral deviation of the upper blade and the lower blade be kept as small as possible across the width of the hard plastic sheet. To obtain a satisfactory, smooth cut surface, the vertical variation between the tips of the upper blade and the lower blade is preferably 0.2 millimeters or less across the width; and the horizontal variation between the tips of the upper blade and the lower blade is preferably 0.1 millimeters or less across the width.

When cutting a continuously flowing hard plastic sheet, the cutting machine is preferably mounted on a synchronous cart capable of moving in the direction of the progress in synchronization with the speed of the hard plastic sheet and capable of moving in the opposite direction and returning.

The hard synthetic resin may for example include thermoplastic resin, thermosetting resin or engineering plastic, such as acrylic resin, metacrylic resin, copolymer resin (MS resin) of methyl methacrylate and styrene, polyolefin resin such as polyethylene (PE), and polypropylene (PP), polycarbonate resin (PC), polyvinyl chloride resin (PVC), polystyrene resin (PS). A typical example of a hard plastic sheet is an acrylic sheet whose rubber content additive rate is 0 or less than 10 percent with a sheet thickness of 0.5 to 20 millimeters.

The present invention possessing the above described structure can attain a cutting machine with high accuracy cutting, a short cutting time and without generating cutting waste since the hard plastic sheet is cut with brittle fracture. The present invention can achieve a smoothly cut surface since the hard plastic sheet is cut with brittle fracture in a bent state centered at the cutting position during cutting.

### BRIEF DESCRIPTION OF DRAWINGS

The aforesaid and other objects and features of the present invention will become more apparent from the following detailed description and the accompanying drawings.

FIG. 1 is a frontal view showing an embodiment of the present invention;

FIG. 2 is a view showing in detail the extrusion machine section of FIG. 1

FIG. 3 is a drawing showing the structure of the work support roll and the work clamp;

FIG. 4 is a perspective view showing the upper blade cartridge;

FIG. 5A is a cross sectional view taken along line A-A of FIG. 4;

FIG. 5B is a cross sectional view taken along line B-B of FIG. 4;

FIG. 5C is a cross sectional view taken along line C-C of FIG. 4;

FIG. 6 is a perspective view showing the lower blade cartridge;

FIG. 7A is a cross sectional view taken along line A-A of FIG. 6;

FIG. 7B is a cross sectional view taken along line B-B of FIG. 6;

FIG. 7C is a cross sectional view taken along line C-C of FIG. 6;

FIG. 8 is a frontal cross sectional view showing the upper bed section of the cutting machine;

FIG. 9 is a frontal cross sectional view showing the lower bed section of the cutting machine;

FIG. 10 is a drawing showing the positional interrelation of the upper blade and the lower blade;

FIG. 11A is a cross sectional view of the upper blade cartridge as another example;

FIG. 11B is a cross sectional view of the lower blade cartridge as another example;

FIG. 12A is a cross sectional view of the upper blade cartridge as yet another example;

FIG. 12B is a cross sectional view of the lower blade cartridge as yet another example;

FIG. 13A is a cross sectional view of the upper blade cartridge as still another example;

FIG. 13B is a cross sectional view of the lower blade cartridge as still another example;

### DESCRIPTION OF PREFERRED EMBODIMENTS

A preferred embodiment of the present invention is described next while referring to the drawings.

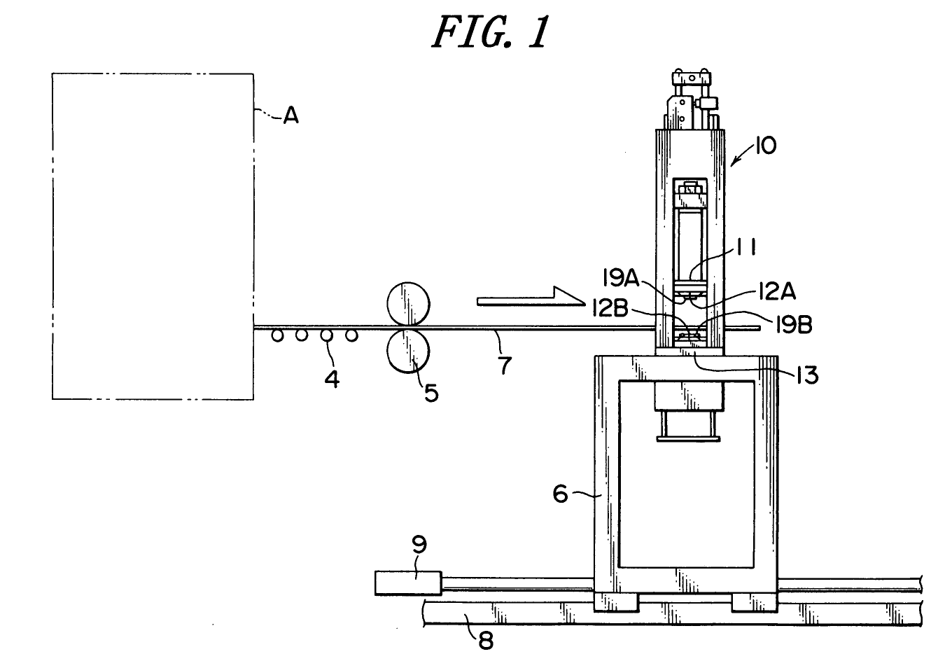

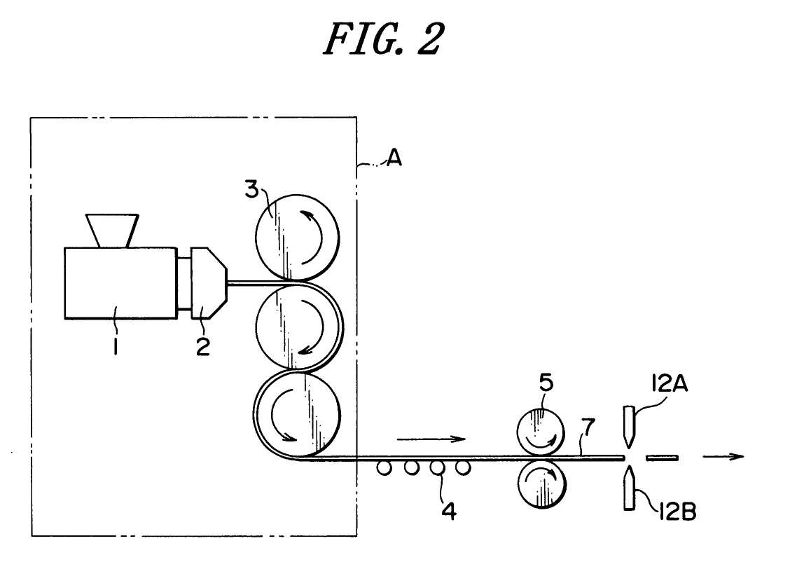

An extrusion machine 1, a die 2, rolling rolls 3, guide rolls 4, draw rolls 5, and a synchronous cart 6 are arranged in this sequence from the left as shown in FIG. 1 and FIG. 2.

The extrusion machine 1 heats and melts the thermoplastic resin such as acrylic resin. The thermoplastic resin is heated by the extrusion machine 1 and kneaded in the melted state and fed continuously to the die 2. The heating temperature is the melting temperature of the thermoplastic resin or higher.

The heated and melted thermoplastic resin is formed into a sheet shape and extruded from the die 2 at a speed for example of 10 to 30 meters per minute. The conventional T die may be utilized as the die 2. The die 2 may extrude a single layer of thermoplastic resin, and may extrude multiple layers of two layers or three layers or more. A continuous single layer sheet can be produced by utilizing the die for extruding a single layer sheet. A continuous multiple layer sheet can be produced by using the die for extruding a multiple layer sheet and jointly extruding two or more types of thermoplastic resin. Thermoplastic resin is consecutively sent from the extrusion machine 1 to the die 2 so that the die 2 consecutively extrudes the thermoplastic resin. The thickness of a hard plastic sheet 7 extruded from the die 2 is usually 0.5 millimeters or more and usually 20 millimeters or less. The width of the hard plastic sheet 7 is usually 0.5 meters or more, and preferably one meter or more, and normally 3 meters or less.

The hard plastic sheet 7 may be extruded from the die 2 and conveyed directly to a cutting machine 10 for cutting by upper and lower blades 12A, 12B. However, in the system shown in the figure, the hard plastic sheet 7 extruded from the die 2 is rolled by the rolling rolls 3 and then conveyed to the cutting machine 10. The diameter of the rolling rolls 3 is usually about 15 to 60 centimeters. The hard plastic sheet 7 extruded from the die 2 is rolled by the rolling rolls 3. The number of the rolling rolls 3 to roll the hard plastic sheet 7 may be two or more and there is no particular limit. The system shown in the drawing, however, utilizes three rolling rolls 3. The hard plastic sheet 7 extruded from the die 2 is first of all rolled by the first rolling roll 3 and the second rolling roll 3, and then being wound on the second rolling roll 3, is again rolled by the second rolling roll 3 and the third rolling roll 3. The device A made up of the extrusion machine 1, the die 2, and the rolling rolls 3 in this way continuously extrudes an acrylic sheet at a fixed speed. For example, the speed is 1 meter per minute, the thickness of the sheet is 4 millimeters, and the width of the sheet is 1500 millimeters.

The hard plastic sheet 7 is pulled by the draw rolls 5 such as nip roll while guided by the multiple guide rolls 4 and conveyed in the extrusion direction. A protective film is in some cases attached to one surface or both surfaces of the hard plastic sheet 7 by nip rolls, etc. The hard plastic sheet 7 may also be cooled during conveyance.

The synchronous cart 6 is mounted on a pair of rails 8 arranged in parallel along the moving direction of the hard plastic sheet 7. The synchronous cart 6 is first at an initial position on the left side. It can move to the right by means of a cart drive device 9, and can also move to the left and then return to the initial position. A rotary encoder is built into the draw roll 5 to detect the number of roll rotations. By utilizing this signal from the rotary encoder, a control means controls the cart drive device 9 to move the synchronous cart 6 in synchronization with the movement of the cutting position of the hard plastic sheet 7.

The cutting machine 10 is mounted on the upper section of the synchronous cart 6. The cutting machine 10 has an upper blade 12A set in an upper bed 11 capable of moving up and down, and a lower blade 12B set in a fixed lower bed 13. The upper blade 12A and the lower blade 12B are mounted at opposite positions above and below the hard plastic sheet 7. The upper blade 12A and the lower blade 12B are belt-shaped blades extending linearly along the width direction of the hard plastic sheet 7. The upper blade 12A and the lower blade 12B are longer than the width of the hard plastic sheet 7.

The main specifications of the cutting machine 10 are as follows.
Maximum cutting width: 1700 millimeters
Pressurizing force: 400 kilonewtons
Stroke: 100 millimeters (during continuous operation)
Daylight: 194 millimeters
No load descent speed: 20 millimeters per second
Descent speed during pressing: 9 millimeters per second
Driving speed: 31 millimeters per second

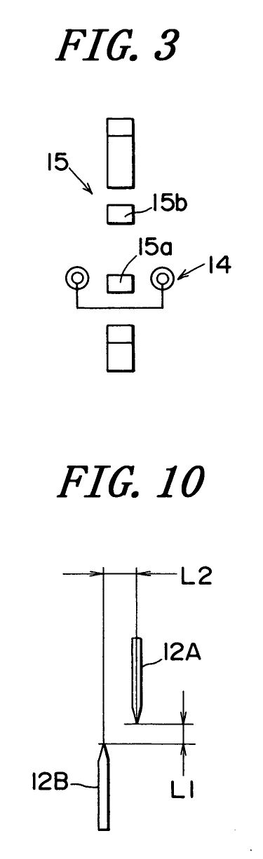

Work support rolls 14 and work clamps 15 shown in FIG. 3 are mounted at the front and rear positions of the upper blade 12A and the lower blade 12B. The work support roll 14 rises and supports the hard plastic sheet 7 during supply of the hard plastic sheet 7, and lowers during cutting. The work clamp 15 includes a work support 15a installed below, and a work clamp 15b installed above. The work clamp 15b rises during supply of the hard plastic sheet 7 and lowers during cutting. The work clamp 15b lightly clamps the hard plastic sheet 7 during cutting to prevent the hard plastic sheet 7 from vibrating at the cutting position and stabilizes the position. The height of the work support roll 14 during supply of the hard plastic sheet 7 is set at a height where the hard plastic sheet 7 does not make contact with upper and lower blade cartridges 16A, 16B described later. The height of the work support 15a of the work clamp 15 is set at a lower height than the work support roll 14 during cutting.

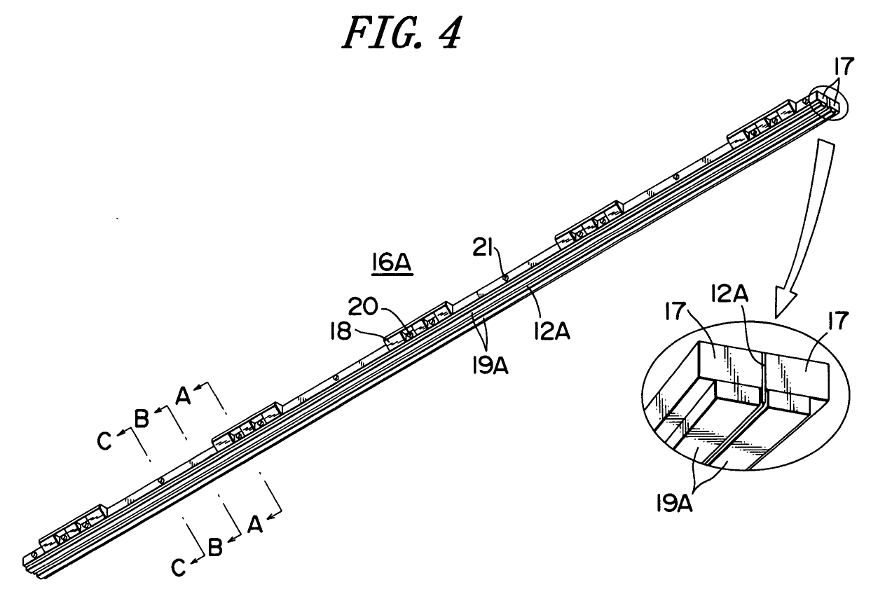

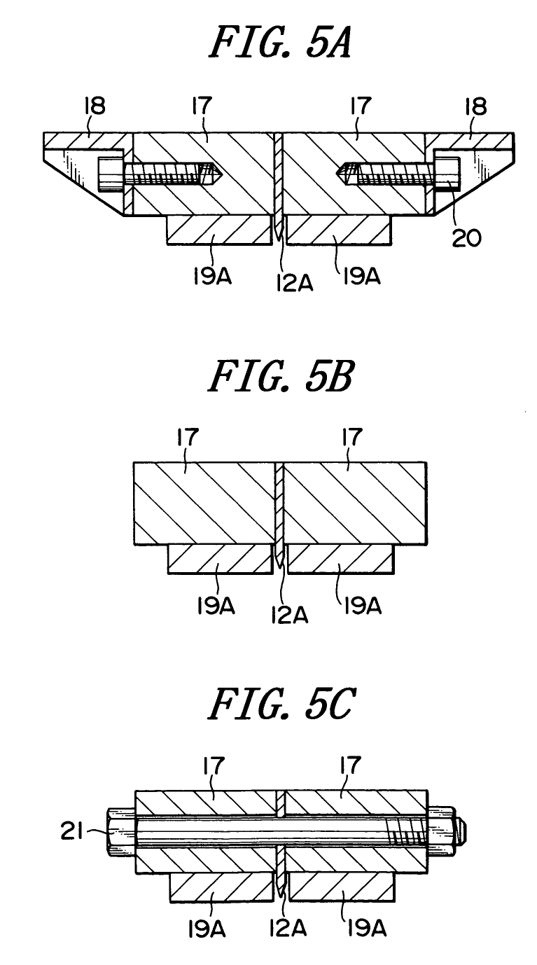

The upper and lower blade cartridges 16A, 16B are described next while referring to FIG. 4, FIGS. 5A-5C, FIG. 6, and FIGS. 7A-7C.

As shown in FIG. 4 and FIGS. 5A-5C, the upper blade cartridge 16A is comprised of a pair of support blocks 17 installed adjacent to each other, multiple clamping taper blocks 18 secured to the respective outer sides of the pair of support blocks 17, the upper blade 12A comprised of one belt-shaped Thompson blade secured between the inner side surfaces of the pair of support blocks 17, and a pair of resilient members 19A installed on both sides of the upper blade 12A.

Each of the support blocks 17 is made up of square rod with a rectangular cross section and longer than the width of the hard plastic sheet 7. The clamping taper block 18 is a block with a cross section roughly in the shape of a right triangle, and secured by bolts 20 at five equally spaced locations longitudinally on the support block 17. The upper blade 12A is secured between the pair of support blocks 17 by a bolt-nut means 21. The tip of the upper blade 12A protrudes from one surface of the support blocks 17. The length of the upper blade 12A is longer than the width of the hard plastic sheet 7. The resilient member 19A is made from narrow rubber sponge plate with a rectangular cross section. The resilient member 19A is installed on both sides of the tip of the upper blade 12A and bonded to the surface of the support block 17.

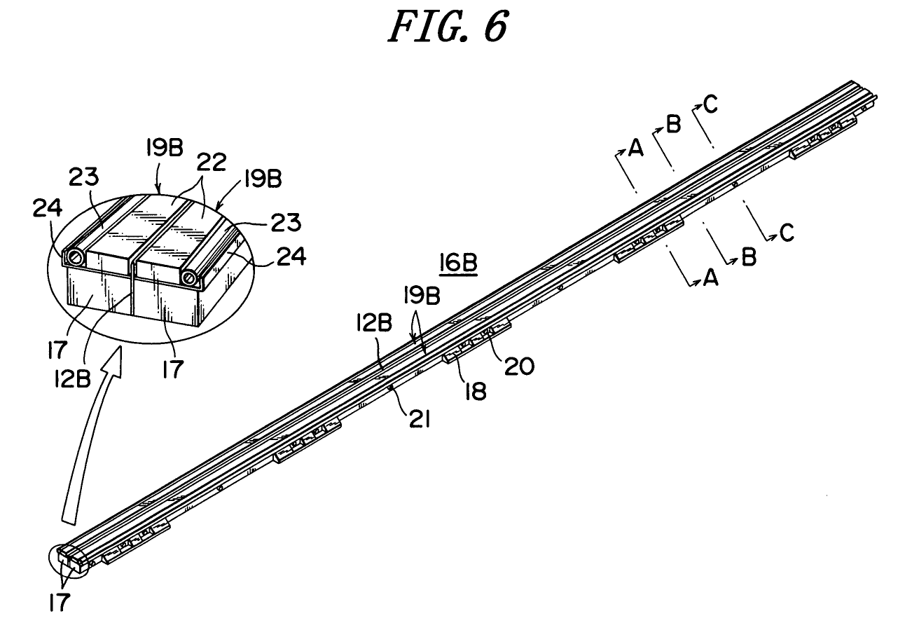

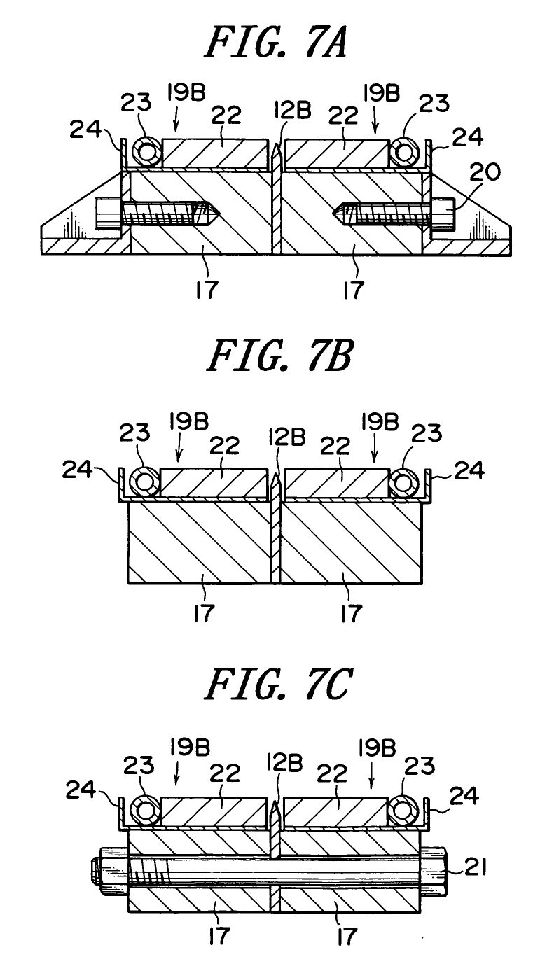

The support blocks 17, the clamping taper blocks 18, and the lower blade 12B of the lower blade cartridge 16B (See FIG. 6 and FIGS. 7A-7C.) are identical to the upper blade cartridge 16A. However, the structure of a pair of resilient members 19B is different from the upper blade cartridge 16A. The resilient member 19B of the lower blade cartridge 16B is comprised of a resilient member 22 (hereafter, inner resilient member) on the side near the blade, and a resilient member 23 (hereafter, outer resilient member) on the side far from the blade. The lower blade cartridge 16B further includes a deformation suppressing member 24 for suppressing the deformation of the outer resilient member 23 on the outer side of the outer resilient member 23 or in other words, at a section farther from the blade than the outer resilient member 23. The inner resilient member 22 is made from narrow rubber sponge plate with a rectangular cross section. The outer resilient member 23 is made from nylon tube. The deformation suppressing member 24 is a thin stainless steel plate with an L-shaped cross section made from a horizontal base plate and a perpendicular upright plate. A space is formed between the upright plate of the deformation suppressing member 24 and the outer resilient member 23 to suppress excessive deformation of the outer resilient member 23. The deformation suppressing member 24 with the upright plate arranged on the outer side is bonded to the surface of the support block 17. The outer resilient member 23 and the inner resilient member 22 are bonded to the base plate surface of the deformation suppressing member 24. The cutting machine having this type of lower blade cartridge structure is ideal for cutting a hard plastic sheet of a thickness of 5 millimeters or less.

The resilient member 19A of the upper blade cartridge 16A and the inner resilient member 22 of the lower blade cartridge 16B possess the same thickness and hardness and protrude out slightly further than the tips of the upper and lower blades 12A, 12B. The blade tips of the upper and lower blades 12A, 12B do not protrude from the resilient members 19A, 19B unless pressure is applied to the resilient members 19A, 19B, and hands and fingers are not damaged. The outer resilient member 23 of the lower blade cartridge 16B is the same height as the inner resilient member 22, and is set to a higher hardness than the inner resilient member 22.

The surface on the opposite side to the tip of the upper blade 12A in the pair of support blocks 17 of the upper blade cartridge 16A forms a reference surface 17a. Taper surfaces 18a of the pair of clamping taper blocks 18 are formed to widen towards the reference surface 17a. The surface on the opposite side to the tip of the lower blade 12B in the pair of support blocks 17 of the lower blade cartridge 16B forms a reference surface 17b. Taper surfaces 18b of the pair of clamping taper blocks 18 are formed to widen towards the reference surface 17b.

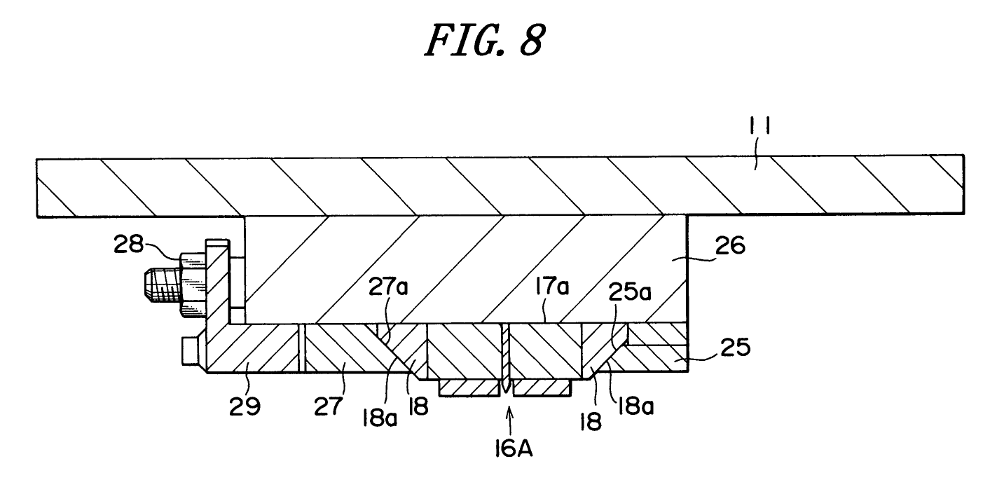

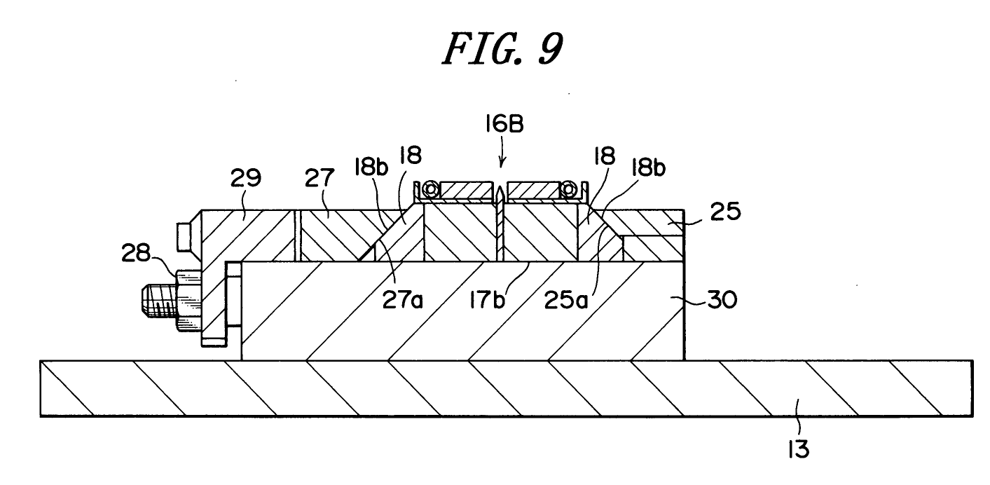

The upper and lower blade cartridges 16A, 16B are set in the cutting machine 10 as shown in FIG. 8 and FIG. 9.

As shown in FIG. 8, reference taper blocks 25 are secured at five equally spaced locations perpendicular to the flow direction of the hard plastic sheet 7, on the lower surface forming the reference surface of an upper base plate 26 secured to the upper bed 11 of the cutting machine 10. A clamping taper block 27 is installed at a relative position to the reference taper block 25, on the lower surface forming the reference surface of the upper base plate 26. The clamping taper block 27 is installed for front and rear movement along the lower surface forming the reference surface of the upper base plate 26, on a cross sectional L-shaped member 29 clamped by a bolt-nut means 28 on the upper base plate 26. The clamping taper block 27 is capable of advancing or retreating relative to the reference taper block 25 by means of an air cylinder not shown in the drawing. The reference taper block 25 and the clamping taper block 27 contain taper surfaces 25a, 27a on their respective relative surfaces. Both of these taper surfaces 25a, 27a are formed to widen towards the lower surface of the upper base plate 26.

As shown in FIG. 9, the reference taper block 25 and the clamping taper block 27 are also installed on the upper surface forming the reference surface of a lower base plate 30 secured to the lower bed 13 of the cutting machine 10, the same as the upper bed 11 side.

As shown in FIG. 8, when the upper blade cartridge 16A is set in the cutting machine 10, the upper blade cartridge 16A is inserted longitudinally into the space of the cross sectional trapezoid enclosed by the upper base plate 26 clamped to the upper bed 11, the reference taper block 25 and the clamping taper block 27, and when the clamping taper block 27 is pressed to the reference taper block 25 side by the air cylinder, the reference surface 17a is pressed to the reference surface of the upper base plate 26, along with the taper surface 18a of the clamping taper block 18 being pressed to the taper surface 25a of the reference taper block 25 so that the upper blade cartridge 16A is accurately positioned and clamped.

As shown in FIG. 9, the lower blade cartridge 16B is set the same as above, on the lower bed 13 side.

In this invention, the tips of the upper blade 12A and the lower blade 12B apply a brittle fracture point to the hard plastic sheet 7. Therefore, to obtain a satisfactory, smooth cut surface, as shown in FIG. 10, the variation in the blade tip gap L1 in the vertical direction of the upper blade 12A and the lower blade 12B is 0.2 millimeters or less across the width; and the variation in the blade tip gap L2 in the horizontal direction is 0.1 millimeters or less across the width.

The operation of the cutting machine 10 is described next.

The hard plastic sheet 7 continuously extruded from the die 2 is pulled by the draw rolls 5, placed on the work support rolls 14 and flows rearward at a specified speed. When the cutting position for the hard plastic sheet 7 reaches the upper blade 12A and the lower blade 12B position of the cutting machine 10, the cart drive device 9 is controlled by a control means to move the synchronous cart 6 by a signal from the rotary encoder built into the draw roll 5, so that the synchronous cart 6 starts to move rearward in synchronization with the speed of the hard plastic sheet 7.

The work support roll 14 next lowers and separates from the hard plastic sheet 7, and the work clamp 15b of the work clamp 15 lowers and lightly clamps the hard plastic sheet 7. The lowering of the upper bed 11 of the cutting machine 10 make the upper blade 12A lower towards the lower blade 12B and both the resilient members 19A, 19B for the upper blade 12A and the lower blade 12B make contact with the hard plastic sheet 7. When the upper blade 12A lowers further, the upper blade 12A and the lower blade 12B bite into the top and bottom surfaces of the hard plastic sheet 7 and at the same time, both the resilient members 19A, 19B for the upper blade 12A and the lower blade 12B are compressed. The resilient member 19B installed on both sides of the lower blade 12B is comprised of the inner resilient member 22 and the outer resilient member 23 and the hardness of the inner resilient member 22 is lower than that of the outer resilient member 23 so that the hard plastic sheet 7 is simultaneously held by the resilient members 19A, 19B installed on both sides of the upper and lower blades 12A, 12B, and the hard plastic sheet 7 bends with the bottom being protruded downwards. Moreover, when the upper blade 12A lowers towards the lower blade 12B, and the lower blade 12B on the protruding side of the bent hard plastic sheet 7 bites 0.2 to 0.5 millimeters into the hard plastic sheet 7, a brittle fracture spreads from the blade tip and the hard plastic sheet 7 is cut.

When the cutting is detected, the upper bed 11 on the cutting machine 10 rises and along with the work support roll 14 rising and supporting the hard plastic sheet 7, the work clamp 15b of the work clamp 15 rises and separates from the hard plastic sheet 7. Next, the synchronous cart 6 moves in the direction opposite the hard plastic sheet 7 flow, returns to the initial position, and stands by until the hard plastic sheet 7 moves a specified distance.

Compared to the cutting machine disclosed in Japanese patent Non-Examined Publication No. 2001-322096, in the cutting machine 10 of this invention, a bend is concentrated on the cutting position of the hard plastic sheet 7, and this bend becomes large at the cutting position section. Therefore, the change in the bend per descent distance of the upper blade 12A becomes larger. Brittle fracture therefore occurs all at once across the width of the hard plastic sheet 7 so that brittle fracture progresses in the thickness direction of the sheet, and the progress along the lateral direction becomes smaller, so the cut surface is smooth. Variations in the amount of bite-in of the blade (upper blade 12A in this embodiment) on the side where brittle fracture progresses when brittle fracture starts are small so few cutting defects such as whiskers occur.

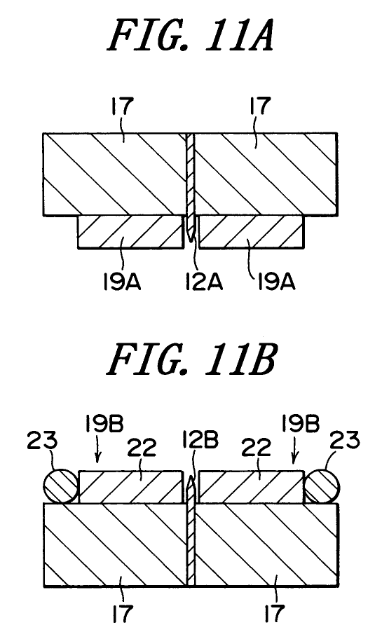

Another embodiment of this invention is shown in FIGS. 11A-11B. In this embodiment, the structure of the lower blade cartridge is different from the above described embodiment. The points differing from the above described embodiment are described next. In the lower blade cartridge of this embodiment, the outer resilient member 23 is made up of a hard rubber rod with a circular cross section and there is no deformation suppressing member that is installed in the above embodiment. A cutting machine containing this lower blade cartridge is ideal for cutting a hard plastic sheet of 5 millimeters thickness or less.

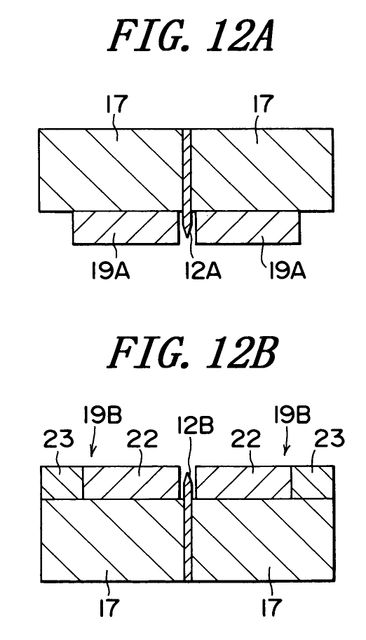

Another embodiment of this invention is shown in FIGS. 12A-12B. In this embodiment, the structure of the lower blade cartridge is different from the above described embodiment. The points differing from the above described embodiment are described next. In the lower blade cartridge of this embodiment, the outer resilient member 23 is made up of a hard rubber plate with a rectangular cross section, and there is no deformation suppressing member as is installed in the previous embodiment. A cutting machine containing this lower blade cartridge is ideal for cutting a hard plastic sheet with a thickness of 3 millimeters or more.

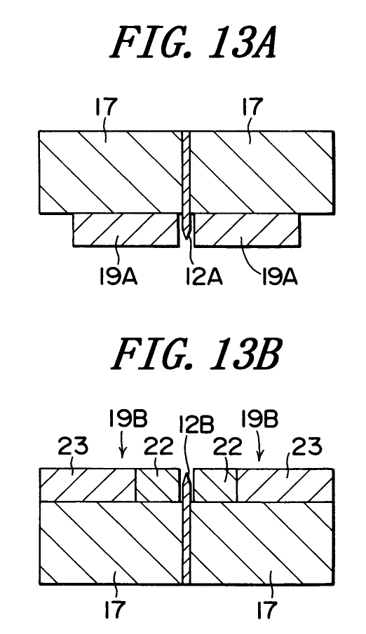

Another embodiment of this invention is shown in FIGS. 13A-13B. In this embodiment, the structure of the lower blade cartridge is different from the above described embodiment. The points differing from the above described embodiment are described next. In the lower blade cartridge of this embodiment, the hardness of the inner resilient member 22 is set to a higher hardness than the outer resilient member 23. In other words, the inner resilient member shown in FIGS. 12A-12B is installed on the outer side, and the outer resilient member is installed on the inner side. The inner resilient member 22 is therefore made from hard rubber plate with a rectangular cross section, and the outer resilient member 23 is made from rubber sponge plate with a rectangular cross section. A cutting machine containing this lower blade cartridge is ideal for cutting a hard plastic sheet with a thickness of 3 millimeters or more.

One feature of the present invention is that forming the cross section of the outer resilient member 23 in ring or circular shape makes it more difficult for separation of the protective film to occur during cutting, if the hard plastic sheet is covered by a protective film.

The shapes of the resilient members 19A, 19B of this invention are not limited to the above described shapes and may be formed in a suitable shape as required by circumstances.

Although the present invention has been described with reference to the preferred embodiments, it is apparent that the present invention is not limited to the aforesaid preferred embodiments, but various modifications can be attained without departing from its scope.

What is claimed is:

1. A cutting machine comprising an upper blade and a lower blade installed at upper and lower positions, and resilient members installed on both sides of the blades and protruding more than the blades for supporting a hard plastic sheet during cutting, wherein
the resilient members installed on both sides of either of the upper and lower blades include a resilient member at a section near the blade and a resilient member at a section far from the blade; and the hardness of the resilient member at a section near the blade is different from the hardness of the resilient member at a section far from the blade.

2. A cutting machine as claimed in claim 1, wherein the hardness of the resilient member at a section near the blade is lower than the hardness of the resilient member at a section far from the blade.

3. A cutting machine as claimed in claim 2, wherein the cross section of the resilient member at a section far from the blade is a circular or ring shape.

4. A cutting machine as claimed in claim 2, wherein a deformation suppressing member is installed to suppress deformation of the resilient member at a section far from the blade.

5. A cutting machine as claimed in claim 1, wherein the hardness of the resilient member at a section near the blade is higher than the resilient member at a section far from the blade.

6. A cutting machine as claimed in claim 1, wherein the blade tips of the upper blade and the lower blade are a linear shape.

7. A cutting machine as claimed in claim 6, wherein a variation in the blade tip gap in the vertical direction of the upper blade and the lower blade is 0.2 millimeters or less across the width, and a variation in the blade tip gap in the horizontal direction of the upper blade and the lower blade is 0.1 millimeter or less across the width.

8. A cutting machine as claimed in claim 1, wherein the cutting machine is mounted on a synchronous cart capable of moving in synchronization with the speed of the continuous flow of the hard plastic sheet in the progress direction, and moving in the reverse direction and returning.

9. A cutting machine as claimed in claim 1, wherein the hard plastic sheet is acrylic sheet with a thickness of 0.5 to 20 millimeters, and a rubber content additive rate of 0 or less than 10 percent.

10. A manufacturing system for fixed size sheet comprising a cutting machine as claimed in claim 1, and a die for forming heated and melted hard synthetic resin in a sheet shape and continuously extruding a hard plastic sheet, wherein the cutting machine cuts along the width direction, the hard plastic sheet continuously flowing in the extrusion direction from the die.
